(19) United States
(12) Patent Application Publication
(10) Pub. No.: US 2005/0204368 A1
(43) Pub. Date: Sep. 15, 2005

(54) Executable application interoperability and interface creation system

(76) Inventors: Venu Ambekar, Frazer, PA (US); Robert A. Neff, Rosemont, PA (US); John R. Zaleski, West Brandywine, PA (US)

Correspondence Address: Alexander J. Burke;Intellectual Property Department, 5th Floor, 170 Wood Avenue South, Iselin, NJ, 08830, US

(21) Appl. No.: 10/846,264

(22) Filed: May 14, 2004

Related U.S. Application Data
(60) Provisional application No. 60/551,438, filed on Mar. 9, 2004.

(51) Int. Cl. G06F 13/00

(52) U.S. Cl. 719/328

(57) ABSTRACT

A system automatically generates interface code and enables interoperability between a plurality of different executable applications. The system includes first and second calling procedures coded in a common predetermined code language for enabling execution of corresponding first and second procedures of respective first and second different executable applications. An interface processor enables execution of the corresponding first and second procedures of respective first and second different executable applications by using the first and second calling procedures and by providing input parameters to the first and second calling procedures and receiving output parameters from the first and second calling procedures respectively. The output parameters are provided in response to processing of the input parameters by the procedures of the first and second different executable applications

This is a non-provisional application of provisional application Ser. No. 60/551,438 by V. Ambekar et al. filed Mar. 9, 2004.

### FIELD OF THE INVENTION

This invention concerns a system for enabling interoperability between different executable applications and for creating interface code allowing interoperability of the executable applications.

### BACKGROUND OF THE INVENTION

It is commonly required that one or more existing executable software applications of a user or an organization be interoperable with a later acquired and installed different executable application to implement desired functions. A communication interface (termed an adaptation layer) supporting communication of data, instructions and commands between the different executable applications is typically used in order to enable interoperability of such different executable applications. Further, in the event that an existing executable application needs to be interoperable with multiple other different executable applications, known systems typically employ multiple adaptation layers. An adaptation layer is typically employed to support communication between each pair of different executable applications.

The creation of potentially multiple adaptation layers to enable interoperability of multiple executable applications presents a substantial burden in terms of developing, coding and testing the adaptation layers involved. Further, individual executable applications may also have to be modified to cooperate with an adaptation layer, further increasing the development and testing burden. This modification may also be rendered impractical if the size and complexity of the source code makes rewrite unmanageable from a resource or schedule perspective. In addition, the developed adaptation layers are not readily modified to subsequently enable interoperability with an additional different executable application. A system according to invention principles addresses these problems and related problems.

### SUMMARY OF THE INVENTION

A system automatically generates interface code and provides a single comprehensive adaptation interface that seamlessly integrates multiple disparate executable applications that may be plugged in to the adaptation interface to support inter-application communication. A system enables interoperability between a plurality of different executable software applications. The system includes first and second calling procedures coded in a common predetermined code language for enabling execution of corresponding first and second procedures of respective first and second different executable applications. An interface processor enables execution of the corresponding first and second procedures of respective first and second different executable applications by using the first and second calling procedures and by providing input parameters to the first and second calling procedures and receiving output parameters from the first and second calling procedures respectively. The output parameters are provided in response to processing of the input parameters by the procedures of the first and second different executable applications

### BRIEF DESCRIPTION OF THE DRAWING

FIG. 1 shows a typical known executable application interoperability configuration involving two separate adaptation interfaces supporting interoperability with an existing (legacy) executable application.

FIG. 2 shows an adaptation interface system supporting interoperability between multiple different executable applications, according to invention principles.

FIG. 3 shows a layered structure of an adaptation interface system, according to invention principles.

FIG. 4 shows code transformation of executable application APIs supporting interoperability of an executable (Delphi) application and Java application, according to invention principles.

FIG. 5 shows an adaptation interface system supporting interoperability between multiple different executable applications including multiple operating systems, according to invention principles.

FIG. 6 shows a flowchart of a process employed by an adaptation interface system for supporting application interoperability, according to invention principles.

### DETAILED DESCRIPTION OF INVENTION

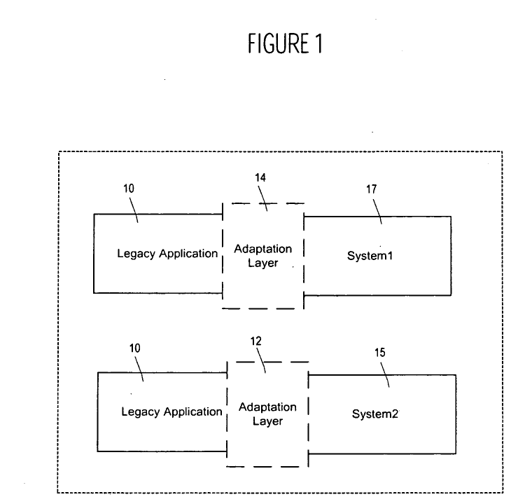

FIG. 1 shows a typical known executable application interoperability configuration involving two separate adaptation interfaces supporting interoperability with an existing (legacy) executable application 10. Two separate different adaptation interfaces 12 and 14 are provided to enable interoperability and bidirectional communication of data, commands and instructions between executable application 10 and executable applications 15 and 17 respectively. This configuration is burdensome on programming development, coding and testing resources as it requires an adaptation layer to be provided to support communication between each pair of different executable applications and the configuration is also difficult to modify and maintain. Existing systems fail to recognize the need for, or to provide, a flexible framework that generates and integrates compatible interface code components (stored in one or more libraries, for example). In such a desirable framework, the interface code components (items of software) are selectable for incorporation in an interface enabling interoperability between two or more executable applications.

Existing Java technology (e.g., Java Native Interface (JNI) technology) supports manually creating java compatible code that interfaces with nonjava programming interfaces. However, this known Java technology is restricted in scope and functionality to interface java code components with non-java code components. Existing Java and other coding technology fails to support interoperability between multiple executable applications. Existing technology also does not provide standardized interface code component libraries nor does it provide automatic generation of template code for individual interface components. Known systems also fail to show a means of using existing interface components coded in different languages for enabling interoperability between multiple executable applications. Conventional known approaches to interfacing multiple executable applications typically involve burdensome re-writes of software programs or non-trivial traditional interface development. Also, in conventional systems, interfacing an additional executable application to existing interoperable executable applications requires interfacing of the additional executable application with each of the interoperable executable applications separately.

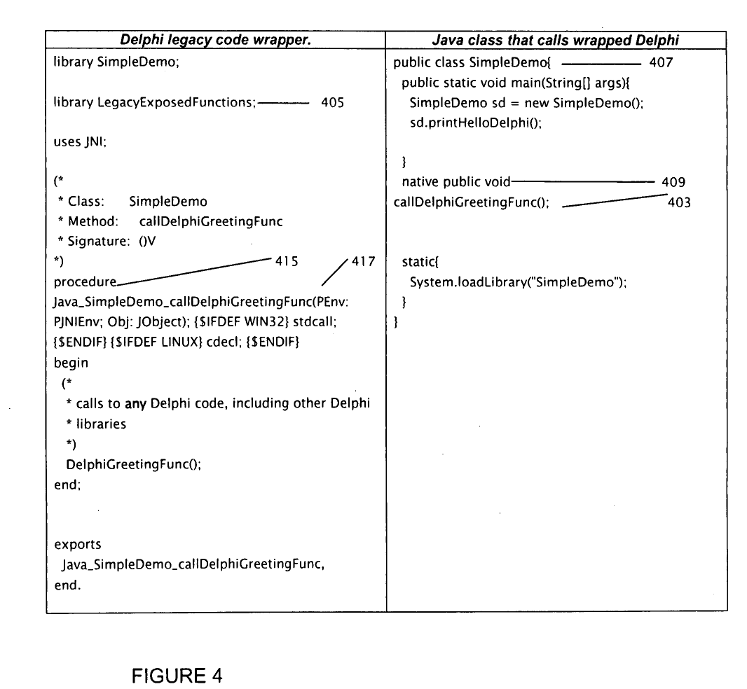

A system according to invention principles automatically generates interface wrapper code encapsulating selected interface code components derived from a library of stored code components to provide resultant interface code components. The resultant interface code components are incorporated in a single comprehensive adaptation interface that seamlessly integrates multiple selected disparate executable applications that may be plugged in to the adaptation interface to support inter-application communication. The adaptation interface eliminates the need to modify executable applications that are being interfaced, including the formatting of their data or changing their data content, thereby advantageously minimizing likelihood of triggering regulatory (e.g., Food and Drug Administration (FDA)) review and is readily employed in interfacing executable applications running under different operating systems (E.g., Linux and Microsoft Windows XP, other mainframe/DB,200VAX). Known configurations, as exemplified in FIG. 1, require nC2 (possible combinations of 2) adaptation layers to enable interoperability of n executable applications. In contrast, an adaptation interface system according to invention principles, involves the creation and maintenance, of substantially fewer, (specifically n) adaptation layers. For example, if there are 4 interoperable executable applications, there are 6 adaptation layers in a known adaptation configuration typified by FIGS. 1 and 4 adaptation layers for an adaptation interface system according to invention principles.

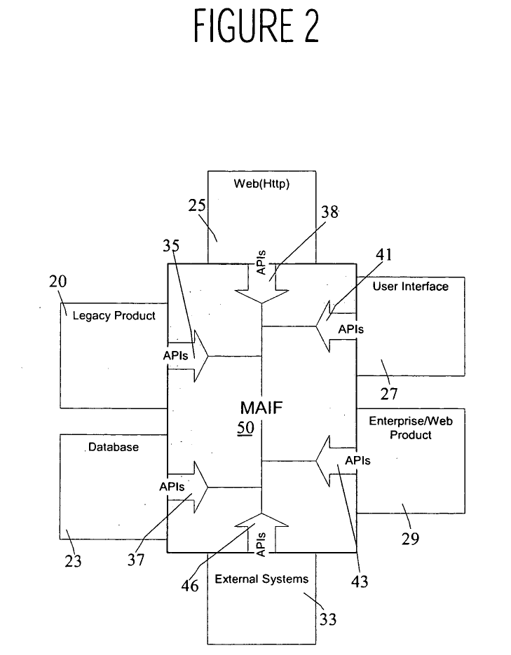

FIG. 2 shows an adaptation interface system 50 (or Multi-Application Interface Framework—MAIF) supporting interoperability between multiple different executable applications. The interface system comprises a single comprehensive interface enabling interoperability between multiple different executable applications and is easy to maintain and extend to be interoperable with additional executable applications as required. The burden involved in developing and testing an interface system according to invention principles is reduced relative to previous known processes due in part to automatic generation of wrapper code encapsulating selected interface code components derived from a library of stored code components. Multiple executable applications may be plugged in to adaptation interface system 50 and are thereby able to communicate with the other executable applications already bidirectionally communicating and operating via adaptation interface system 50.

The system of FIG. 2 also automatically generates thin layer interface wrapper code encapsulating selected interface code components derived from a library of stored code components (such as functional Application Programming Interfaces (APIs)) to provide resultant interface code components. The generated interface wrapper code encapsulating selected interface code components provide standard programming interfaces employing predetermined conventions that may be directly used by an executable application that is to be added to the interface system. The system eliminates the necessity for modifying the code of an executable application to be incorporated with the interface system which facilitates integration and interoperability.

An executable application as used herein comprises code or machine readable instruction for implementing predetermined functions including those of an operating system, healthcare information system or other information processing system, for example, in response user command or input. An executable procedure as used herein is a segment of code (machine readable instruction), sub-routine, or other distinct section of code or portion of an executable application for performing one or more particular processes and may include performing operations on received input parameters (or in response to received input parameters) and provide resulting output parameters. A calling procedure is a procedure for enabling execution of another procedure in response to a received command or instruction. A processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. An object as used herein comprises a grouping of data, executable instructions or a combination of both or an executable procedure.

FIG. 2 illustrates an adaptation interface enabling interoperability of a number of executable applications including a pre-existing (legacy) application 20, a database management application 23, an Internet based application 25, a user interface (e.g., a web browser) application 27, an organization specific Internet based application 29 and an external remote application 33. The system enables pre-existing (legacy) application 20 and organization specific Internet based application 29, for example, to access database application 23 and enables user interface application 27 to access the functions of pre-existing (legacy) application 20. Applications 20-33 are able to mutually cooperate and an individual application is able to access functions of any of the other applications of applications 20-33. These applications may include a variety of different software products, including existing (legacy) products and Web-based user interfaces and other Web-compatible products that are able to mutually cooperate and share functions via adaptation interface system 50.

Individual applications of applications 20-33 are interoperable and able to bidirectionally communicate through communication plane 50 via corresponding respective Application Programming Interfaces (APIs) 35-46. An API of APIs 35-46 comprises encapsulated software interface code. Specifically, an API comprises an encapsulated code component of a static and dynamic code component library such as a library including components with .dll & lib extensions, and shared objects. The resulting generated encapsulated software interface code API components are stored in standard libraries compatible with a desired programming language. The encapsulated API components are called (i.e., their execution is initiated) through method invocation by executable applications 20-33. Java compatible class libraries are generated, for example, by encapsulating programming interfaces of an existing executable application 20 (e.g. a legacy Delphi application). Furthermore, the generated Java compatible libraries may be used by Java executable applications to seamlessly and transparently access functions provided by existing executable application 20.

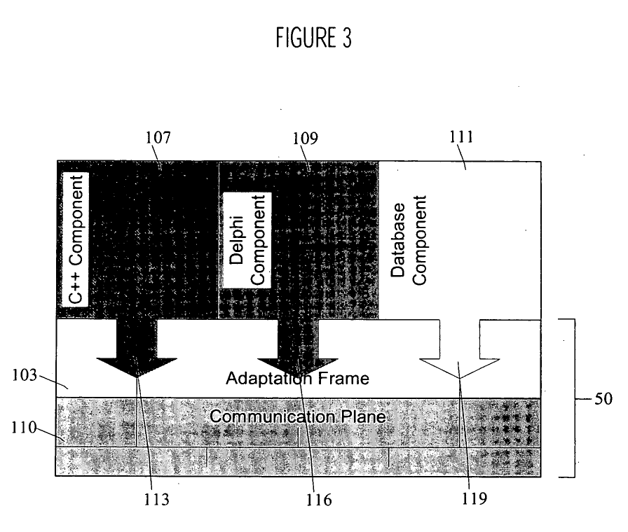

FIG. 3 shows an exemplary layered structure of adaptation interface system 50 (FIG. 2) implemented using a JNI (Java Native Interface). JNI employs a special set of standard java classes that allow a Java application to call functions from pre-compiled libraries regardless of how the libraries are written (i.e. the library does not have to have been written in java language). Consequently, a library routine implemented in C++, or C may be initiated using such a java class, for example. The FIG. 3 structure includes three layers in this embodiment (additional layers may be involved in other embodiments). Adaptation interface system 50 enables interoperation of executable applications 107, 109 and 111 in a first layer. Application 107 uses C++ programming language, application 109 is a proprietary application (e.g., a Delphi application) and application 111 is a database application. A second layer 103 includes adaptation layer code for the individual applications 107, 109 and 111. The adaptation layer code of layer 103 includes APIs 113, 116 and 119 that are encapsulated using a Java Native Interface to provide standardized Java compatible APIs. Encapsulated APIs 113, 116 and 119 provide interfaces for corresponding applications 107, 109 and 111 respectively. A third layer 110 supports inter-application communication via encapsulated standardized APIs 113, 116 and 119 enabling an individual application of applications 107, 109 and 111 to communicate with other applications of applications 107, 109 and 111.

Adaptation interface system 50 enables C++ application 107 to access the functions of application 109 and database application 111 through encapsulated standardized APIs 113, 116 and 119. Similarly, application 109 is able to access the functions of the C++ application 107 and database application 111 through encapsulated standardized APIs 113, 116 and 119, Further, database application 111 is able to access the functions of the C++ application 107 and application 109. The communication enabling interoperability occurs in communication layer 110.

Adaptation interface system 50 involves transforming the interface code or APIs of executable applications 107, 109 and 111 into encapsulated standardized APIs 113, 116 and 119. In this embodiment Java is used as a standard programming language together with JNI. An individual executable application is added into the adaptation interface system 50 using adaptation layer code that comprises standard Java APIs that map to native APIs of executable applications (i.e., APIs implemented in the programming languages of the corresponding applications) that are connected using adaptation interface system 50. Thereby, an individual executable application is able to access functions of other executable applications by calling corresponding adaptation interface system 50 standard Java procedures used for initiating execution of the application functions. If a calling procedure used for initiating execution of an application function is a Java executable procedure, it is able to initiate a standard Java calling procedure. If a calling procedure used for initiating execution of an application function is other than a Java procedure, then the adaptation layer for that application maps the non-Java procedures (native APIs) of the application to the standard Java calling procedure. The mapping of calling procedures from standard Java calling procedures to non-Java (native) APIs and the reverse mapping of the non-Java procedures (native APIs) to the standard Java calling procedures are implemented in adaptation layer 103. Adaptation interface system 50 generates interface wrapper code encapsulating APIs (derived from a library of stored APIs) for adaptation layer 103 that are used to provide interoperability between applications 107, 109 and l 11. The system generates encapsulation code (stub-code) for an API of an executable application based upon characteristics of the executable application. The characteristics include the programming language used by the executable application and the operating system the application runs on, for example.

FIG. 4 illustrates transformation of executable application APIs supporting interoperability of an executable proprietary (Delphi) application and Java application used in an adaptation layer of an adaptation interface system such as system 50 of FIGS. 2 and 3. In this example, APIs are transformed to adaptation interface system 50 standard Java APIs supporting interoperability of a first Delphi application and a second Java executable application. The Delphi application provides functions through an API—callDelphiGreetingFunc( ) 403 that is implemented in an existing (LegacyExposedFunctions) library 405. The encapsulation code generated by the adaptation interface system makes the function (callDelphiGreetingFunc( )) 403 available to other Java components.

Adaptation interface system 50 constructs a simple encapsulation Java class (SimpleDemo) 407. The method callDelphiGreetingFunc( ) 403 is declared with a native modifier 409. A call to this method is similar to making other method calls on a Java class. However, the class in which this method is declared does not contain an implementation for this method, instead SimpleDemo class 407 contains a static method invocation for System.loadLibrary(“LegacyExposedFunctions” 405). The method loads the Delphi library LegacyExposedFunctions.dll file. A dll (dynamic link library) file extension indicates a file containing a collection of Windows functions designed to perform a specific class of operations. Creation of the SimpleDemo library is explained below.

A JNI header (SimpleDemo.h) file is generated using adaptation interface system 50 by applying a utility procedure to the SimpleDemo Java class. The header file contains the declarations and mapping of data-types from Java to be compatible with a Delphi application, in this example. Further, adaptation interface system 50 automatically generates encapsulation code for a Delphi executable procedure shown in FIG. 4 following item 415. Procedure 415 incorporates method Java_SimpleDemo_callDelphiGreetingFunc( ) 417. This method contains a direct API call into a Delphi application (in this example it is DelphiGreetingFunc( )from the LegacyExposedFunctions library). FIG. 4 depicts portions of code that identify the calls from a Java procedure to a Delphi application and illustrates use of JNI to support communication of the Delphi library via Java.

In the example presented in FIG. 4, methods DelphiGreetingFunc( ) 417 (provided by the Delphi component) and callDephiGreetingFunc( ) 403 do not receive input parameters or provide output parameters. However, in another embodiment, input parameters are conveyed to a library procedure and non-zero valued output parameters are acquired from the library procedure. The code of FIG. 4 enables a Java executable application to make calls to initiate procedures via the APIs provided by a Delphi executable application through JNI function. Similarly, a Delphi executable application is able to make calls to initiate procedures via Java APIs through JNI function (not shown to preserve drawing clarity). In a similar manner, a Delphi application is able to interoperate with a C++ executable application. For this purpose, a Delphi application API comprises an encapsulated standard Java API using JNI and a C++ application API is encapsulated into a Java API using JNI. The Delphi executable application makes a call to initiate a procedure via a Java API (using JNI) corresponding to the C++ application. Thereby, the Delphi executable application initiates a procedure of the C++ application. In a similar way, the C++ application is able to make calls to initiate executable procedures in the Delphi application. An adaptation interface is implemented in programming languages like C/C++, Java/JNI and employs a JNI extension to support programming languages not currently supported by JNI.

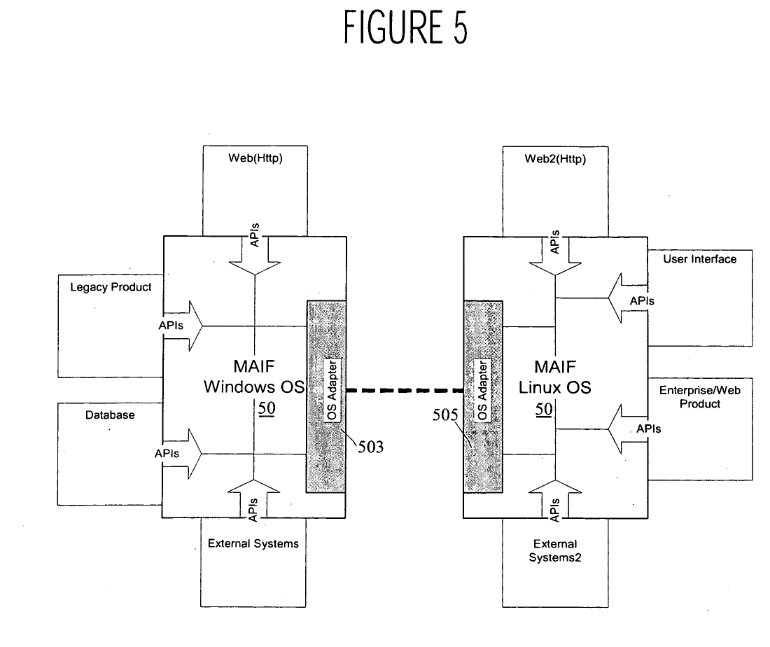

FIG. 5 shows adaptation interface system 50 supporting interoperability between multiple different executable applications including multiple operating systems. The adaptation interface enabling interoperability between different applications running under different operating systems (such as Microsoft Windows and Linux) may use TCP/IP protocol and XML to enable interoperability, for example. Additional adaptation interface modules 503 and 505 enable inter-operating system bidirectional communication. Adaptation module 503 operating on a Windows operating system communicates with adaptation module 505 operating on a Linux operating system enabling applications on the Windows operating system to seamlessly interoperate with applications operating on the Linux operating system. This principle of operation may be readily extended to enable interoperability of applications operating under more than two operating systems and other system than Windows and Linux (e.g., Unix compatible operating systems).

Adaptation interface system 50 is applicable to other software fields by enabling incorporation and use of libraries of interface procedures (e.g., dlls) without requiring rewriting/modification of code of applications into another programming language to enable interoperability. It may be difficult or impractical to rewrite such code for a number of reasons including, cost, schedule, or resource reasons. Adaptation interface system 50 integrates different executable applications operating on different operating systems, such as Windows and Linux and enables interoperability of Windows and Linux executable procedures. Adaptation interface system 50 also incorporates scalable functions and may be operated in conjunction within a distributed computing architecture using a high reliability platform. Adaptation interface system 50 employs a standard encapsulation (wrapper) code format (in another embodiment non-standard encapsulation code formats are used) that allows seamless integration of different executable applications with minimal additional adaptation code regardless of the specific function of the original executable application code and without requiring modification of language libraries of the applications. System 50 employs encapsulation (wrapped) precompiled proprietary software code libraries and encapsulates a library file regardless of how or when it was originally created in order to facilitate application interoperability. System 50 integrates applications written in different programming languages and obviates the need to re-write executable application code in order to enable interoperability with a different application written in the same or a different programming language. System 50 is usable to integrate software associated with a medical device into a Clinical information system, for example, by employing standardized encapsulation code enabling integration of the medical device code with an executable application product.

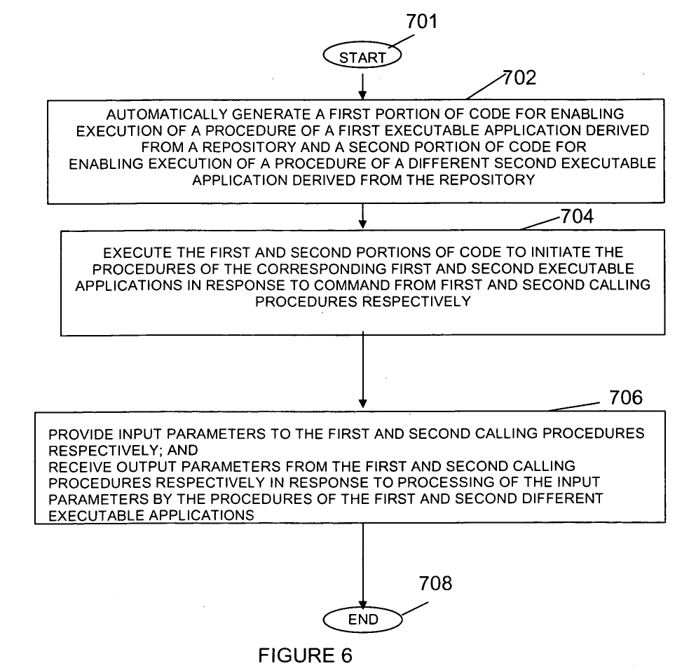

FIG. 6 shows a flowchart of a process employed by adaptation interface system 50 (FIG. 1) for supporting application interoperability. In step 702 after the start at step 701, system 50 automatically generates a first portion of code for enabling execution of a procedure of a first executable application and a second portion of code for enabling execution of a procedure of a second executable application. The first and second portions of generated code employ a common predetermined code language and require application specific code elements (that are manually or automatically programmed) to produce calling procedures for initiating execution of procedures derived from a library or repository of procedures of the first and second executable applications. The first and second portions of generated code comprise template code that operates with the application specific code elements to produce the calling procedures. The common predetermined code language comprises JAVA, C or C++ and also uses Java Native Interface (JNI) language, a scripting language or XML, for example, and may comprise machine executable processed code derived from such source code. The first and second different executable applications in one embodiment, are Microsoft Windows, Linux or Unix—operating system (or associated) applications.

In step 704, system 50 executes the first and second portions of code to initiate the procedures of the corresponding first and second executable applications in response to command from first and second calling procedures respectively. In step 706, system 50 provides input parameters to the first and second calling procedures and receives output parameters from the first and second calling procedures respectively, in response to processing of the input parameters by the procedures of the first and second different executable applications. Alternatively, system 50 receives output parameters from the first and second calling procedures respectively, without receiving or processing input parameters. The process of FIG. 6 terminates at step 708.

The system and processes presented in FIGS. 1-5 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system automatically generates interface code and provides a single comprehensive adaptation interface that seamlessly integrates multiple disparate executable applications that may be plugged in to the adaptation interface to support inter-application communication. Further, any of the functions provided by system 50 (FIG. 1) may be implemented in hardware, software or a combination of both.

### GLOSSARY

Calling A Calling procedure is an executable procedure that initiates the Procedure execution of a function or subroutine.
Interoperable An executable application that needs to interoperate with another executable executable application (coded in the same or a different application programming language) via the adaptation interface system
JNI Java Native Interface—A utility package provided by SUN Microsystems, Inc. This package provides the capability to have a java code make initiate calls into non-java executable procedures or vice-versa.
MAIF Multi-Application Integration Framework.
Stub-code Code for encapsulating code comprising an executable procedure such as an API (Application Programming Interface), for example.
Wrapper Code Code that encapsulates APIs, for example. An executable application makes calls into wrapper code that in turn makes calls into underlying APIs. A wrapped API of an executable application is interoperable with another executable application via calls into wrapper code.
Wrapper Wrapper code compiled into libraries or shared objects. libraries Applications that require to call the functions/subroutines of the wrapper code load/link the wrapped libraries during run-time.
Compatible These are libraries compatible with a specific programming libraries language. For example, Java compatible libraries are libraries that can be readily loaded/linked by Java applications.
Platform used interchangeably with operating system but includes hardware along with operating system.

1. A system enabling interoperability between a plurality of different executable applications, comprising:
first and second calling procedures coded in a common predetermined code language for enabling execution of corresponding first and second procedures of respective first and second different executable applications; and
an interface processor for enabling execution of said corresponding first and second procedures of respective first and second different executable applications by using said first and second calling procedures and by providing input parameters to said first and second calling procedures and receiving output parameters from said first and second calling procedures respectively, said output parameters being provided in response to processing of said input parameters by said procedures of said first and second different executable applications.

2. A system according to claim 1, wherein
said first and second calling procedures are derived at least partially by a code generator automatically generating code of said calling procedures.

3. A system according to claim 2, wherein
said generated code comprises template code requiring application specific code elements to produce said calling procedures.

4. A system according to claim 1, wherein
said common predetermined code language comprises one of, (a) JAVA, (b) C and (c) C++.

5. A system according to claim 4, wherein
said common predetermined code language also uses at least one of, (a) Java Native Interface (JNI), (b) a scripting language and (c) XML.

6. A system according to claim 1, wherein
said common predetermined code language comprises machine executable processed code derived from source code.

7. A system according to claim 6, wherein
said common predetermined code language comprises machine executable processed code derived from at least one of, (a) JAVA, (b) C and (b) C++, as source code.

8. A system according to claim 1, wherein
said first and second different executable applications are operating system associated executable applications.

9. A system according to claim 8, wherein
said first and second different executable applications are Microsoft Windows compatible and Linux or Unix compatible applications respectively.

10. A system enabling interoperability between a plurality of different executable applications, comprising:
first and second calling procedures coded in a common predetermined code language; and
a code generator for automatically generating a first portion of code for enabling execution of a procedure of a first executable application and a second portion of code for enabling execution of a procedure of a second executable application different to said first application, said generated code being in said common predetermined code language and said first and second portions of code being executable to initiate said procedures of said corresponding first and second executable applications in response to command from said first and second calling procedures respectively.

11. A system according to claim 10, wherein
said first and second calling procedures provide input parameters to said first and second portions of code respectively and
said first and second calling procedures receive output parameters from said first and second portions of code respectively, said output parameters being provided in response to processing by said procedures of said first and second executable applications.

12. A system according to claim 10 wherein
said first and second calling procedures are derived by at least one of, (a) user programming and (b) automatic code generation.

13. A system according to claim 10, wherein
said common predetermined code language comprises one of, (a) JAVA, (b) and (c) C++.

14. A system according to claim 13, wherein
said common predetermined code language also uses at least one of, (a) Java Native Interface (JNI), (b) a scripting language and (c) XML.

15. A system according to claim 10, wherein
said generated code comprises template code requiring application specific code elements to produce said first portion of code for enabling execution of said procedure of said first executable application and said second portion of code for enabling execution of said procedure of said second executable application.

16. A system enabling interoperability between a plurality of different executable applications, comprising:
first and second calling procedures coded in a common predetermined code language; and
a code generator for automatically generating a first portion of code for enabling execution of a procedure of said first executable application and a second portion of code for enabling execution of a procedure of said second executable application, said generated code being in said common predetermined code language and said first and second portions of code being executable to initiate said procedures of said corresponding first and second executable applications derived from a repository of procedures, in response to command from said first and second calling procedures respectively.

17. A system enabling interoperability between a plurality of different executable applications, comprising:
at least one repository including executable procedures of a first executable application and executable procedures of a second executable application coded in a language different to said first application;
first and second calling procedures coded in a common predetermined code language; and
a code generator for automatically generating a first portion of code for enabling execution of a procedure of said first executable application derived from said at least one repository and a second portion of code for enabling execution of a procedure of said second executable application derived from said at least one repository, said generated code being in said common predetermined code language and said first and second portions of code being executable to initiate said procedures of said corresponding first and second executable applications in response to command from said first and second calling procedures respectively.

18. A system enabling interoperability between a plurality of different executable applications, comprising:
first and second calling procedures coded in a common predetermined code language for enabling execution of corresponding first and second procedures of respective first and second different executable applications; and
an interface processor for enabling execution of said corresponding first and second procedures of respective first and second different executable applications by using said first and second calling procedures and by receiving output parameters from said first and second calling procedures respectively, said output parameters being provided without receiving or processing of input parameters by said procedures of said first and second different executable applications.

19. A method for enabling interoperability between a plurality of different executable applications, comprising the activities of:
using first and second calling procedures, coded in a common predetermined code language, to initiate execution of corresponding first and second procedures of respective first and second different executable applications;
providing input parameters to said first and second calling procedures respectively; and
receiving output parameters from said first and second calling procedures respectively, said output parameters being provided in response to processing of said input parameters by said procedures of said first and second different executable applications.

20. A method for enabling interoperability between a plurality of different executable applications, comprising the activities of:
automatically generating a first portion of code for enabling execution of a procedure of a first executable application and a second portion of code for enabling execution of a procedure of a second executable application different to said first application, said generated code being in a common predetermined code language; and
executing said first and second portions of code to initiate said procedures of said corresponding first and second executable applications in response to command from first and second calling procedures respectively, said first and second calling procedures coded in a common predetermined code language.

21. A method for enabling interoperability between a plurality of different executable applications, comprising the activities:
automatically generating a first portion of code for enabling execution of a procedure of a first executable application derived from at least one repository and a second portion of code for enabling execution of a procedure of a second executable application derived from said at least one repository, said generated code being in a common predetermined code language, said executable procedure of said first executable application and said executable procedure of said second executable application coded in a language different to said first application; and
executing said first and second portions of code to initiate said procedures of said corresponding first and second executable applications in response to command from first and second calling procedures respectively, said first and second calling procedures being coded in a common predetermined code language.
